(19) United States
(12) Patent Application Publication
(10) Pub. No.: US 2025/0050815 A1
(43) Pub. Date: Feb. 13, 2025

(54) RIFLE AND SHOTGUN FASTENING DEVICE

(71) Applicant: Gun Grabber Products Inc., Texarkana, AR (US)

(72) Inventor: Gwen Ann Osborne, Texarkana, AR (US)

(73) Assignee: Gun Grabber Products Inc., Texarkana, AR (US)

(21) Appl. No.: 18/882,745

(22) Filed: Sep. 12, 2024

(51) Int. Cl. B60R 7/14; A47B 81/00

(52) U.S. Cl. CPC B60R 7/14; A47B 81/005

(57) ABSTRACT

A fastening device for safely and securely mounting a long-barrel weapon, such as a shotgun or rifle, to a vertical surface, comprising a vertical fastening plate for attaching the fastening device to the vertical surface. The vertical fastening plate has four aperture holes for inserting screws and attaching the vertical fastening plate to the vertical surface. The fastening device has a horizontal supporting plate for supporting a securing pad and the long-barrel weapon when inserted into the securing pad. The securing pad fits snugly into and mounts on top of the horizontal supporting plate and may be made of a stiff, rubbery material for securely engaging the long-barrel weapon when inserted into the securing pad. The securing pad has a v-shaped recess and a narrow oval opening for receiving the barrel of a weapon when vertically and horizontally inserting the weapon through the v-shaped recess and into the oval opening.

### FIELD OF THE INVENTION

The present invention relates generally to devices for securely and safely fastening long-barrel weapons such as rifles and shotguns to the inside of moving vehicles such as cars, trucks, tractors, golf carts, side-by-sides, boats, ships, and aircraft and to walls and static vertical structures. With the present invention, gun owners can quickly, easily, and safely store and remove their shotguns and rifles from a moving or statically secured storage position.

### BACKGROUND OF THE INVENTION

Gun owners have continuously looked for ways to safely store and quickly and easily remove their weapons without the need for cumbersome belts, straps, locks and other non-user-friendly storage devices. Belts, straps, and locks prevent quick and easy removal of shotguns and rifles, and storing such weapons in a safe and secure manner has been a long-time need for hunters, law enforcement, and military who are constantly on the move in their vehicles, boats, and ships. The need for safely securing long-barrel weapons such as rifles and shotguns is apparent so that the weapons do not discharge while being transported. Hunters may be traveling through the woods and riding over rough terrain and need to rely on their weapons not randomly coming loose or discharging. Law enforcement may be traveling in their vehicles or in high-speed pursuits and need to rely on the same safe storage so that their weapons do not come loose and discharge and are easily accessible and removable in an emergency. The military traveling in their vehicles also need to rely on their weapons not falling out and discharging and are easily accessible during training maneuvers and in combat environments. The present invention safely and securely stores long-barrel shotguns and rifles and makes them more easily accessible than any other invention to date.

A problem with prior art long-barrel weapon securing devices, such as the safety grip in U.S. Pat. No. 6,951,289 to Robert B. Scott, Jr., was the shape of the fasteners and how they held the weapons in place. Prior art securing devices, such as those in the '289 patent, did not mold as easily to the shape of the barrel of a weapon, and they did not easily and securely fasten to the inside of vehicles. They also did not allow a user to store the weapon so that it can be snugly inserted and removed in an upward or downward direction. A need has therefore existed for the shape of a securing device to fasten snuggly and securely to the barrel of a shotgun and rifle, reliably hold the shotgun and rifle in place during transport, and allow for easy removal when needed.

### SUMMARY OF THE INVENTION

The present invention overcomes the failings of the prior art by designing a device that easily and securely fastens to the inside of vehicles while allowing for the safe and secure storage and removal of long-barrel weapons such as shotguns and rifles while being transported.

The fastening device may be screwed to the inside of a vehicle in a vertical fashion at a height equivalent to the barrel of a shotgun or rifle.

The fastening device has a securing pad that is made of a stiff yet flexible rubber material that securely fastens and molds to the shape of the barrels of shotguns and rifles and has a narrow inner oval opening shaped specifically for that purpose.

The securing pad is removable and may be flipped 180° to one side or the other depending upon the preference of the user and whether they desire the weapon to be snugly inserted and removed in an upward or downward direction.

The present invention also works with various accessories that secure the butt end of shotguns and rifles which may be shaped to match and snugly fit the butt ends or loosely fit the ends of the weapons.

### BRIEF DESCRIPTION OF THE DRAWINGS

FIG. 1 is a representative drawing of the fastening device in a typical environment for transporting a shotgun or rifle in a vehicle.

FIG. 2 shows the fastening device from the front view with the securing pad attached in the downward storing position.

FIG. 3 shows the fastening device of FIG. 2 from a top view.

FIG. 4 shows the fastening device of FIG. 2 from an underside view.

FIG. 5 shows the fastening device of FIG. 2 from a left side view.

FIG. 6 shows the fastening device of FIG. 2 from a right side view.

FIG. 7 shows the fastening device of FIG. 2 disassembled into its component parts.

FIG. 8 shows the horizontal supporting plate from a top view.

FIG. 9 shows the disassembled fastening device of FIG. 7 from an underside view.

FIG. 10 shows top view of the securing pad of FIG. 2 in the downward storage position.

FIG. 11 shows the bottom view of the securing pad of FIG. 2 in the downward storage position.

FIG. 12 shows the fastening device of FIG. 2 from a front view but with the securing pad flipped 180° so that a weapon may be stored in an upward inserting and removing direction.

FIG. 13 shows the fastening device of FIG. 12 from a top view.

FIG. 14 shows the fastening device of FIG. 12 from an underside view.

FIG. 15 shows a snug butt mount for snugly securing the butt end of shotgun or rifle to a horizontal surface or the floor of a vehicle.

FIG. 16 shows a loose butt mount for securing the butt end of shotguns and rifles to a wall or vertical surface.

FIG. 17 shows a perspective view of the fastening device with loose butt mount for securing rifles and shotguns to a wall.

### DETAILED DESCRIPTION

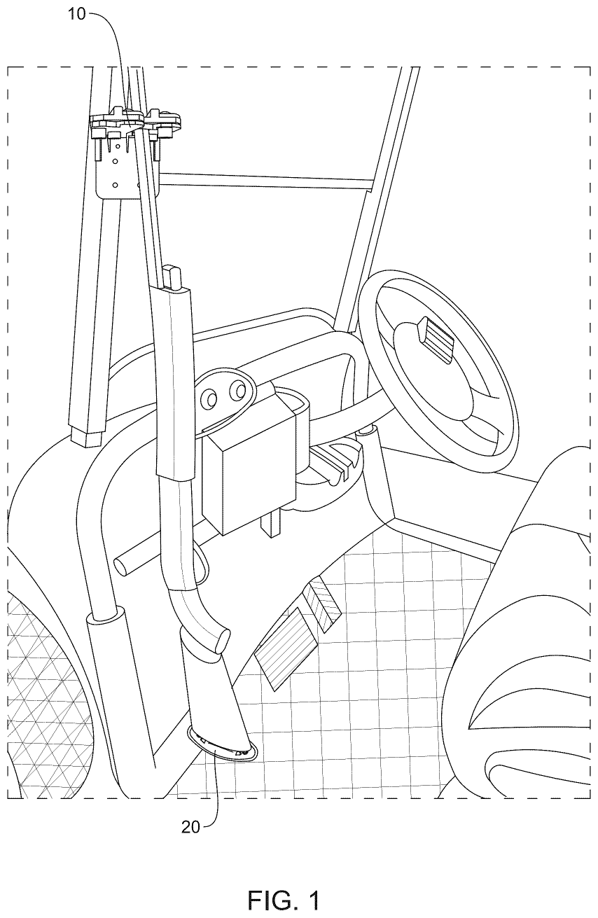

FIG. 1 is a representative drawing of the fastening device 10 in a typical environment for transporting a shotgun or rifle in a vehicle. The figure shows a shotgun in a vertical position secured into the fastening device 10 at the barrel and secured at the butt end in a snug butt mount that is attached by screws to the floorboard of a golf cart. The fastening device 10 and snug button mount 20 are not limited to being installed in golf carts. The fastening device 10 and snug button mount 20 may also be installed in any moving vehicle that has enough room to mount a rifle or shotgun vertically, such as in cars, trucks, tractors, side-by-sides, boats, ships, or airplanes.

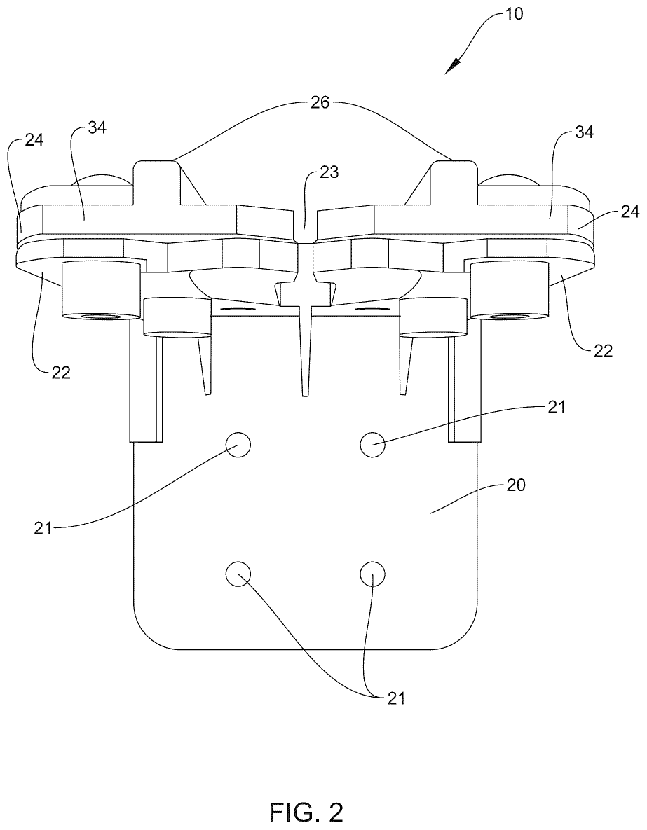

FIG. 2 shows the fastening device 10 from the front view with the securing pad 24 attached in the downward storing position. The fastening device 10 has aperture holes 21 for installing it on a vertical surface with screws through vertical fastening plate 20. The fastening device 10 has a horizontal supporting plate 22 for supporting a securing pad 24 having a v-shaped recess 23 for accepting an insertion of a weapon barrel into the securing pad 24. A shotgun or rifle is stored in the downward storing position by inserting the weapon through v-shaped recess 23 into the securing pad 24 and pulling the weapon downward into the snug butt mount 20. The vertical fastening plate 20 and horizontal supporting plate 22 may be made of a resilient plastic material or military-grade metal.

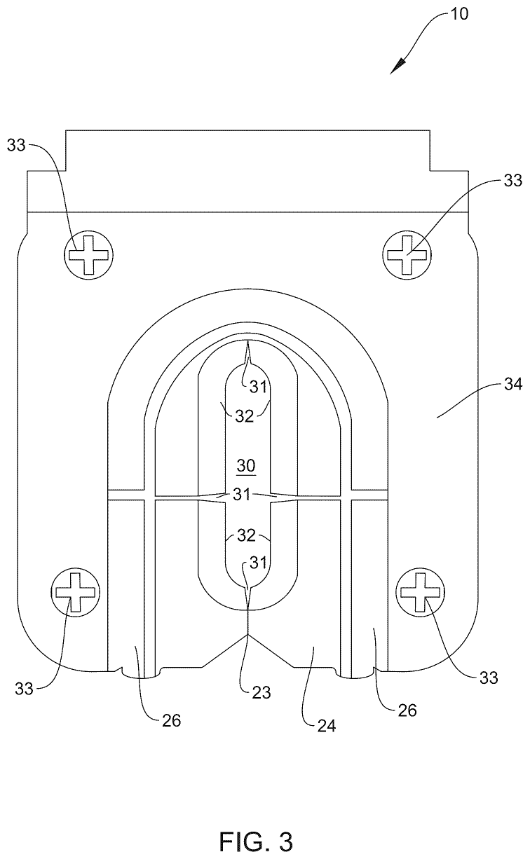

FIG. 3 shows the fastening device 10 of FIG. 2 from a top view. The securing pad 24 provides a narrow oval opening 30 having four securing lips 32 divided by four slits 31 for snugly engaging and molding to the barrels of rifles and shotguns. The oval opening 30 is sized appropriately to be small enough to mold to and engage the width of the barrels of rifles and shotguns with securing lips 32 but not too large to engage the barrels too loosely. Securing pad 24 has a u-shaped rib 26 for engaging and abutting the u-shaped opening of securing pad cover 34. Securing pad cover 34, which also may be made of a resilient plastic material or military-grade metal, covers and protects the securing pad 24 from wear and damage and is attached to the fastening device 10 and securing pad 24 with four securing pad screws 33. The securing pad 24 has a v-shaped recess 23 for receiving a shotgun or rifle that is inserted through the v-shaped recess 23 into oval opening 30 and secured by lips 32 when pulled downward into snug butt mount 20.

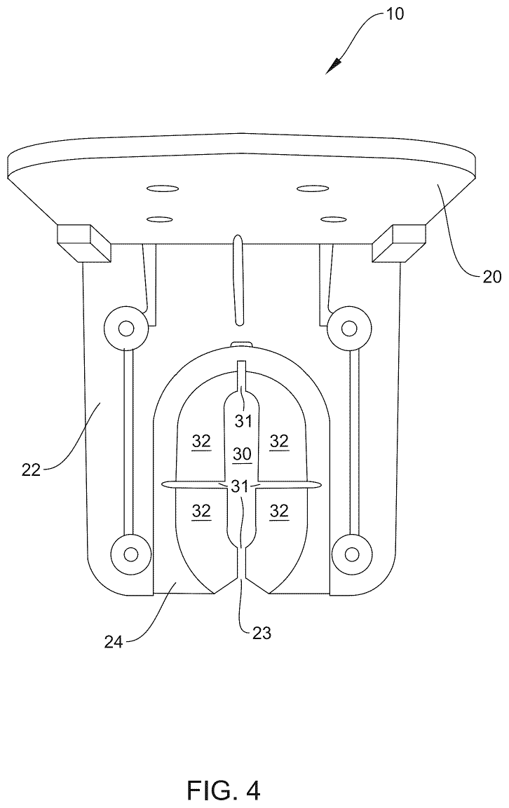

FIG. 4 shows the fastening device 10 of FIG. 2 from an underside view. Shown is the vertical fastening plate 20, horizontal supporting plate 22, securing pad 24 with v-shaped recess 23 and oval opening 30 with slits 31 and securing lips 32. The securing lips 32 are shown extending below securing pad 24 for directly engaging the barrel of weapons in the downward storage direction.

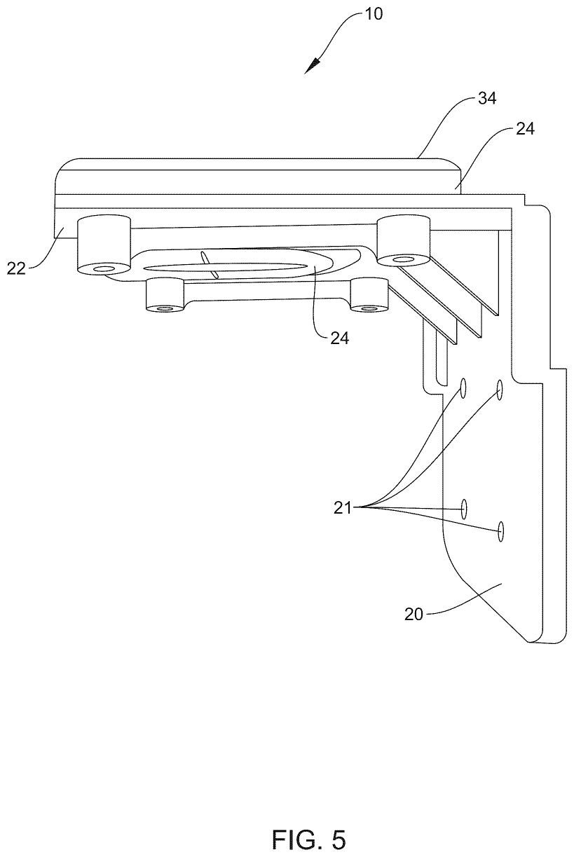

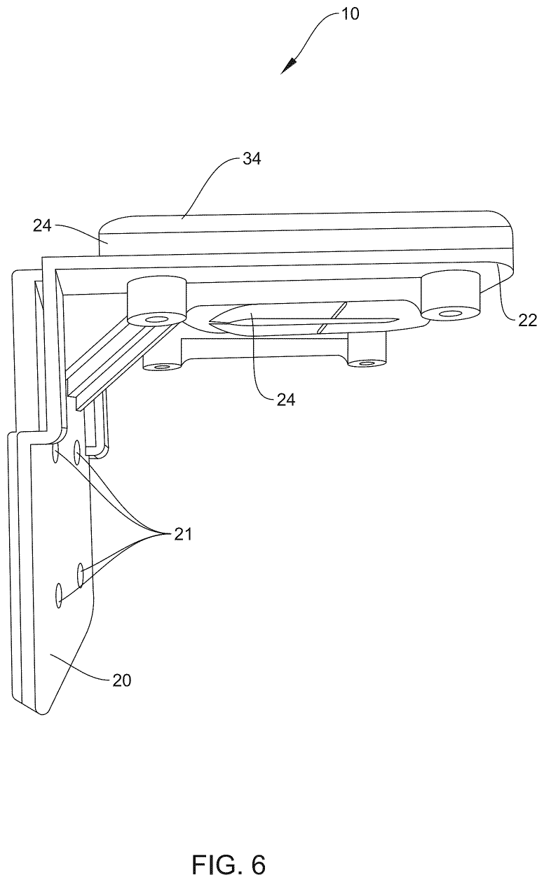

FIG. 5 shows the fastening device 10 of FIG. 2 from a left side view. Shown is vertical fastening plate 32 with holes 21 for securely fastening the device to a vertical surface with screws. Also provided is horizontal supporting plate 22, securing pad 24, and securing pad cover 34 over the securing pad 24. FIG. 6 shows the fastening device of FIG. 2 from a right side view.

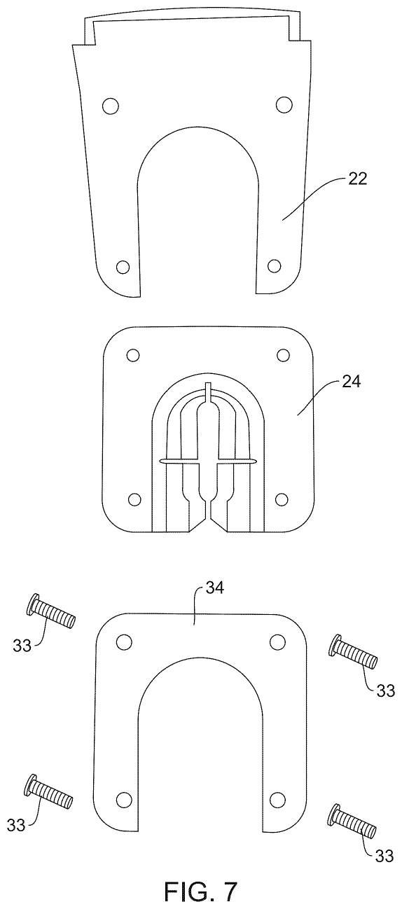

FIG. 7 shows the fastening device 10 of FIG. 2 disassembled into its component parts. The component parts shown are the horizontal supporting plate 22 and the securing pad 24 with oval opening 30, slits 31, and securing lips 32. Also provided is the securing pad cover 34 with four securing pad screws 33.

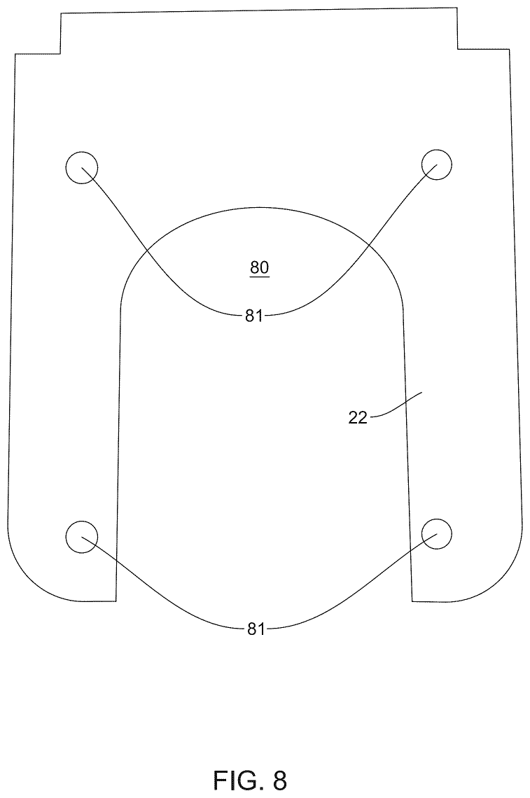

FIG. 8 shows the horizontal supporting plate 22 from a top view. Shown is a u-shaped opening 80 for receiving the inserted securing pad 24. Also provided are four holes 81 for accepting securing pad screws 33.

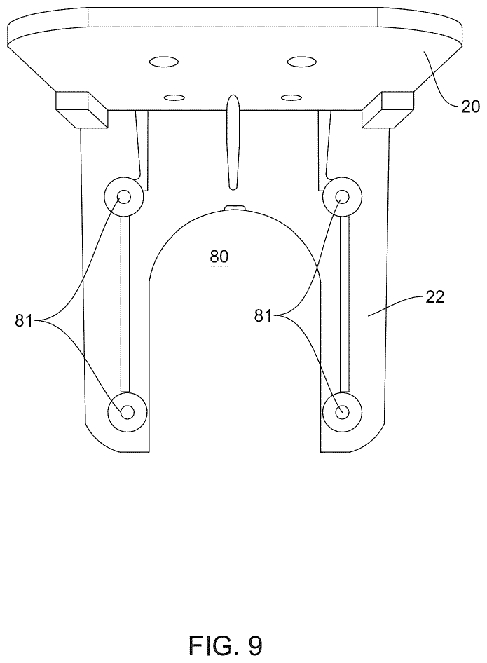

FIG. 9 shows the disassembled fastening device 10 of FIG. 7 from an underside view. Shown are the vertical fasting plate 20, horizontal supporting plate 22, the underside of u-shaped opening 80, and holes 81.

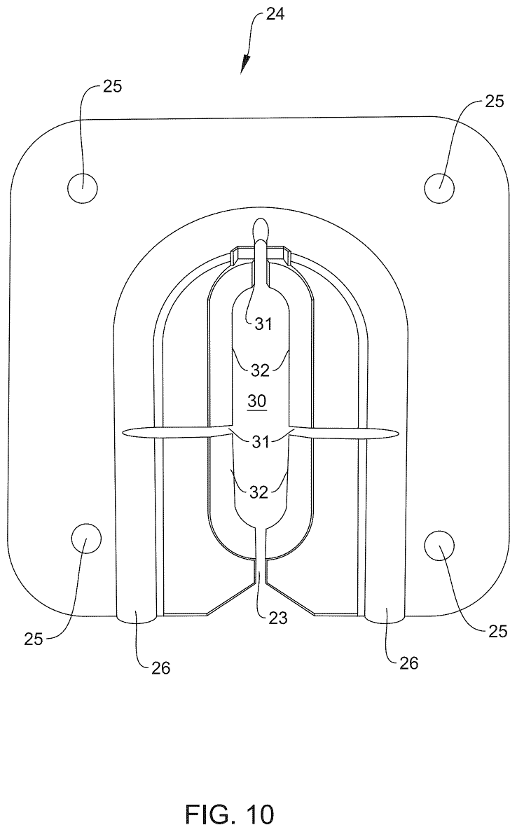

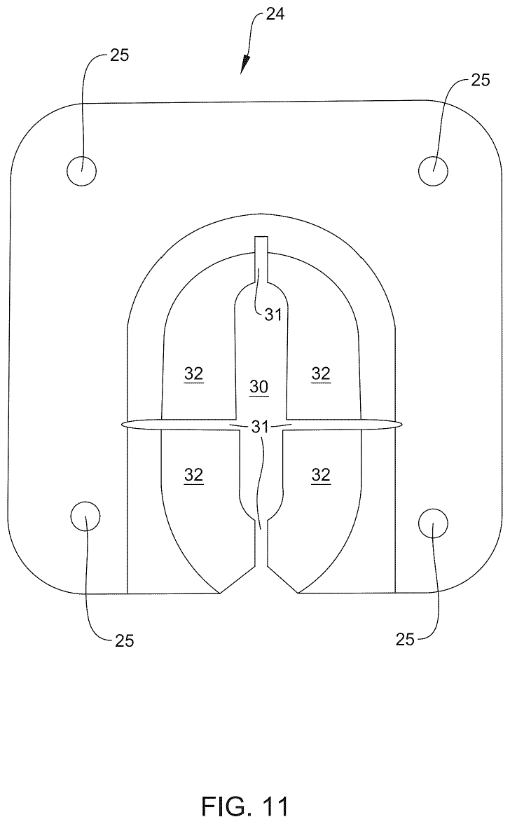

FIG. 10 is a top view of the securing pad 24 in the downward storage position. Shown is the v-shaped recess 23, u-shaped rib 26, oval opening 30 with slits 31 and securing lips 32, and four securing pad aperture holes 25 for accepting securing pad screws 33. FIG. 11 shows the bottom view of the securing pad 24 in the downward storage position.

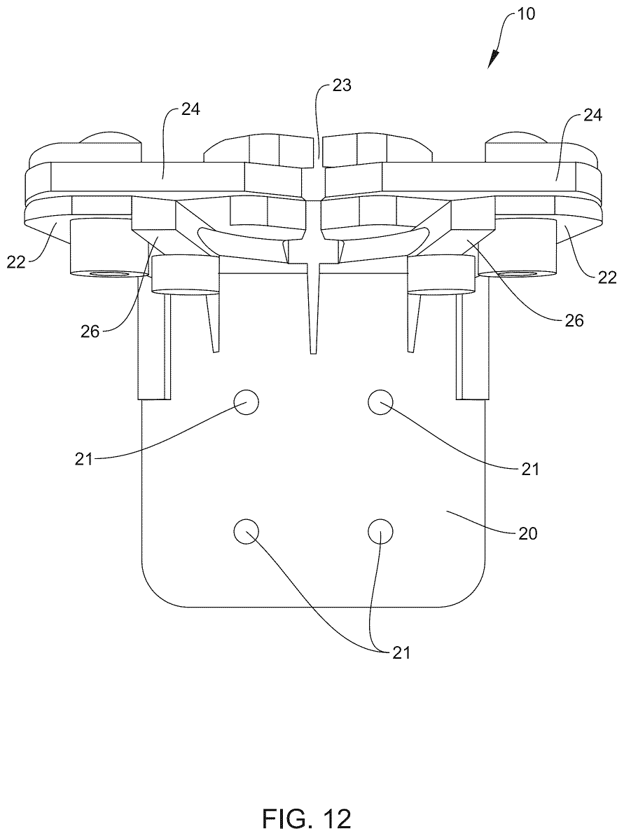

The securing pad 24 may be placed in an upward storing position when it is flipped 180° so that a rifle or shotgun may be inserted through the v-shaped recess 23 into oval opening 30 and engages securing lips 32 and slits 31 in an upward direction and removed in the same direction. FIG. 12 shows the fastening device 10 of FIG. 2 from a front view with the securing pad 24 flipped 180° so that a weapon may be stored in an upward inserting and removing direction. In the upward inserting and removing position, u-shaped rib 26 abuts and snugly engages with the u-shaped opening 80 of horizontal supporting plate 22.

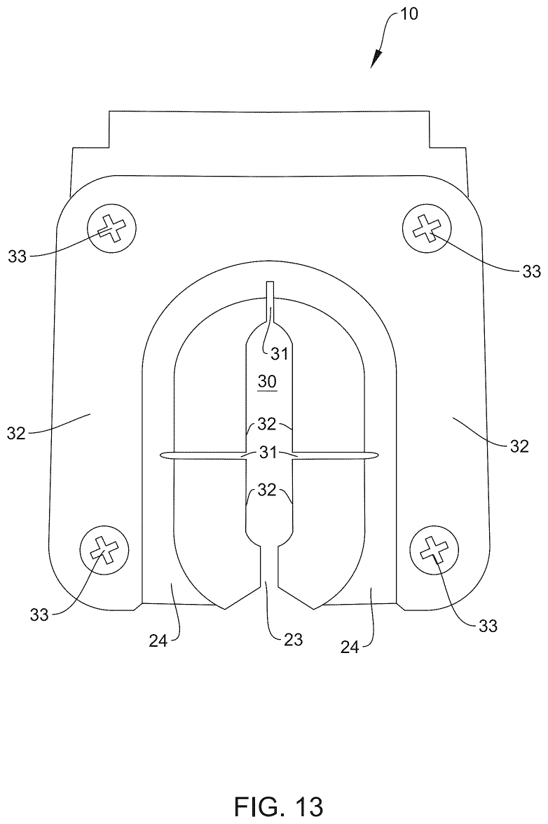

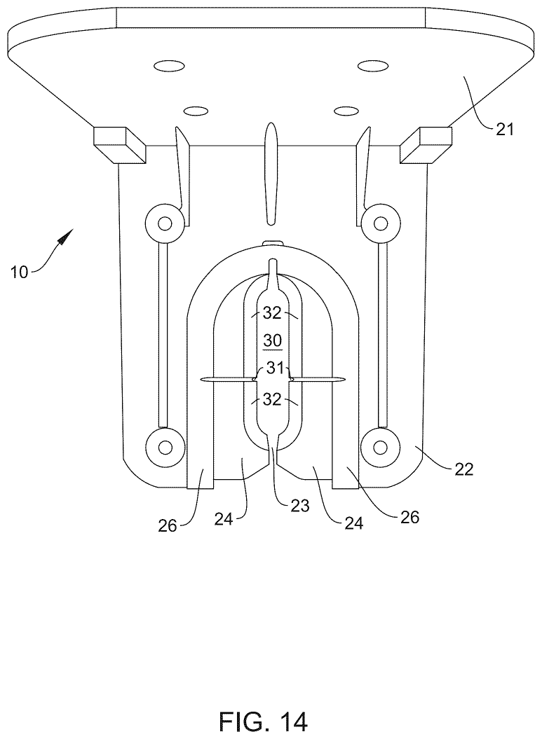

FIG. 13 shows the fastening device 10 of FIG. 12 from a top view for storing weapons in an upward storage position with securing lips 32 shown extending above securing pad 24 for directly engaging and molding to the barrel of weapons in the upward storage position. FIG. 14 shows the fastening device 10 of FIG. 12 from an underside view.

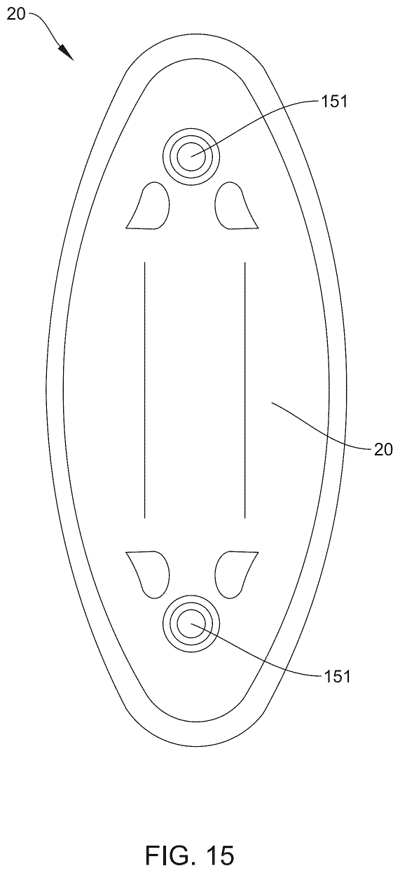

FIG. 15 shows a snug butt mount 20 for snugly securing the butt end of a shotgun or rifle to a horizontal surface such as the floor of a vehicle, boat, and aircraft. The snug butt mount 20 has an oval shape to conform and attach snugly to the butt end of shotguns and rifles when stored in the vertical position. The snug butt mount 20 has two aperture holes 151 for securing the mount to the floors of moving vehicles with screws. The snug butt mount 20 may be made of a flexible yet stiff rubbery material for snugly engaging the butt end of weapons.

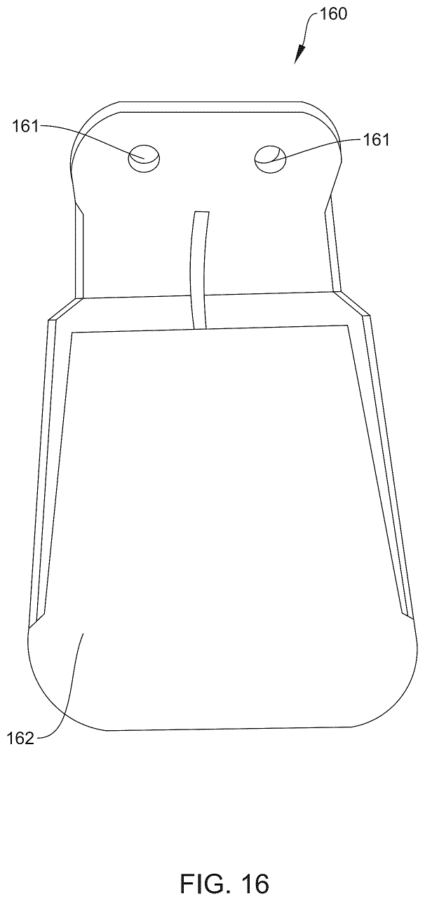

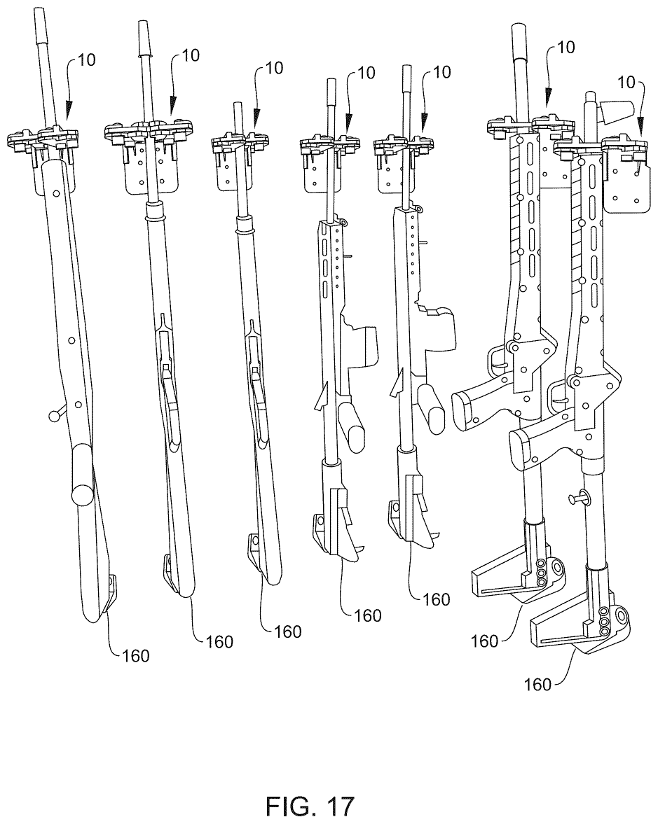

FIG. 16 shows a loose butt mount 160 for securing the butt end of shotguns and rifles to a wall or vertical surface. The mount 160 has a flat surface 162 for holding the butt end of rifles and shotguns and has two aperture holes 161 for attaching the mount 160 to a wall or stationary vertical surface with screws. The loose butt mount 160 may be made of a resilient plastic or metal material. FIG. 17 shows a perspective view of the fastening device 10 with loose butt mount 160 for securing rifles and shotguns to a wall.

The foregoing detailed description provides a general overview for persons of ordinary skill in the art to make and use the invention and is not intended to limit the invention from reasonable equivalents. The invention is further defined with the following claims.

1. A fastening device for safely and securely mounting a long-barrel weapon to a vertical surface, comprising:
a vertical fastening plate for attaching the fastening device to the vertical surface, the vertical fastening plate having aperture holes for inserting screws and attaching the vertical fastening plate to the vertical surface;
a horizontal supporting plate for supporting a securing pad and the long-barrel weapon when inserted into the securing pad;
the securing pad fitting snugly into and being mounted on top of the horizontal supporting plate;
the securing pad being made of a stiff, rubbery material for securely engaging the long-barrel weapon when inserted into the securing pad;
the securing pad having a v-shaped recess and a narrow oval opening for receiving the barrel of a weapon when vertically and horizontally inserting the weapon through the v-shaped recess and into the oval opening;
the oval opening having slits and lips for flexibly engaging, molding to, and snugly holding the barrel of the weapon in a down position when inserted into the securing pad;
the securing pad having a u-shaped rib for engaging a securing pad cover that covers and protects the securing pad, the securing pad cover being attached to the top of the securing pad and horizontal supporting plate with securing pad screws; and
the horizontal supporting plate having a u-shaped opening for snugly engaging the u-shaped rib of the securing pad when the securing pad is flipped 180° for storing the long-barrel weapon in an up position.

2. The fastening device of claim 1, wherein the fastening device may be mounted to the vertical surface of a moving vehicle, such as a golf cart, tractor, side-by-side, car, truck, boat, ship, and aircraft.

3. The fastening device of claim 1, wherein the vertical fastening plate, horizontal supporting plate, and securing pad cover are made of a resilient plastic material or military-grade metal.

4. The fastening device of claim 1, wherein the fastening device may be paired with a snug butt mount for securely mounting a butt end of the long-barrel weapon to a floor of a moving vehicle.

5. The snug butt mount of claim 4, wherein the snug butt mount has an oval shape to securely fit the butt end of the long-barrel weapon.

6. The snug butt mount of claim 4, wherein the snug butt mount may be made of a stiff, rubbery material for securely engaging and holding the butt end of the long-barrel weapon.

7. The snug butt mount of claim 4, wherein the snug butt mount has two aperture holes for attaching the mount to the floor of the moving vehicle with screws.

8. The fastening device of claim 1, wherein the fastening device may be paired with a loose butt mount for mounting a butt end of the long-barrel weapon to a stationary vertical surface.

9. The loose butt mount of claim 8, wherein the loose butt mount has a flat surface for supporting the butt end of the long-barrel weapon when mounted to the stationary vertical surface.

10. The loose butt mount of claim 8, wherein the loose butt mount has two aperture holes for attaching the mount to the stationary vertical surface with screws.

11. The loose butt mount of claim 8, wherein the loose butt mount is made of a resilient plastic or metal material.
